(19) United States
(12) Patent Application Publication
(10) Pub. No.: US 2002/0111874 A1
(43) Pub. Date: Aug. 15, 2002

(54) System and method for network based purchasing

(76) Inventor: Binnur Al-Kazily, Star, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/783,893

(22) Filed: Feb. 13, 2001

(51) Int. Cl. G06F 17/60

(52) U.S. Cl. 705/26

(57) ABSTRACT

A purchasing system of the present invention is provided for buying consumer items from a communications network business through a communications network based on purchasing information gathered from a user environment in accordance with parameters provided by a user. The purchasing system includes a monitoring unit linked with the user environment and a purchasing unit linked with the monitoring unit. The monitoring unit obtains the purchasing information from the user environment in accordance with the user parameters. The purchasing unit generates a consumer item order by assessing the purchasing information. The purchasing system further includes a trader unit linked with the purchasing unit and the communications network. The trader unit selects a communications network business for the consumer item order.

### FIELD OF THE INVENTION

This invention relates to a network based purchasing system and method. In particular, the invention relates to a communications network based system and method for obtaining purchasing information from a user environment and purchasing goods and services, via the Internet, using the purchasing information as a guideline.

### BACKGROUND OF THE INVENTION

Typically, purchasing a replacement ink cartridge for a printer is a time consuming and laborious task. Purchasing a replacement ink cartridge, for example, requires finding relevant cartridge dealers in a telephone book, placing a call to the appropriate dealer to verify availability, driving to the dealer, making a purchase, and driving back with a suitable cartridge. Whether it is buying a replacement printer ink cartridge or a flea collar for a pet, often trivial purchasing errands consume a large part of an individual's work day.

Today, at the turn of the twenty first century, communications networks, such as the worldwide web, are expanding as the number of network user subscribers continues to increase. In particular, commercial business activities conducted on the Internet continue to grow significantly. From established businesses, such as large manufacturing and investment firms, to newly formed Internet start-up companies, such as online auctioneers, a very broad range of businesses conduct business transactions on the Internet.

Thus, as a matter of maximizing business time and efficiency, there is a clear need for an automated purchasing system for making informed purchases of goods and services provided on the Internet with parameters provided by a user relating to that user's ongoing consumer needs. In addition to maximizing time and efficiency, an automated purchasing system eliminates the need for engaging in less pleasurable shopping experiences, such as physically leaving work in order to shop for mundane items like printer cartridges and flea collars, for example. Therefore, it is an object of this invention to provide a system and method for obtaining purchasing information from a user environment so as to buy goods and services via the Internet based on that purchasing information.

### SHORT STATEMENT OF THE INVENTION

Accordingly, a purchasing system of the present invention is provided for buying consumer items from a communications network business based on purchasing information gathered from a user environment in accordance with parameters provided by a user. The purchasing system includes a monitoring unit linked with the user environment and a purchasing unit linked with the monitoring unit. The monitoring unit obtains the purchasing information from the user environment in accordance with the user parameters. The purchasing unit generates a consumer item order by assessing the purchasing information. The purchasing system further includes a trader unit linked with the purchasing unit and the communications network. The trader unit selects a communications network business for each consumer item order. The user environment includes at least one peripheral device such as a printer, for example, at least one database device such as a wireless telephone, for example, and a network plugin device, such as a building's electrical lighting timers for example.

In particular, the monitoring unit includes an order collection system that senses a consumer item demand signal from the user environment. The monitoring unit includes an intelligent monitoring agent linked with the order collection system and with the purchasing unit for generating purchasing information from the consumer item demand signal.

The intelligent purchasing agent preferably accesses purchasing information from an inventory collection system to determine whether a consumer item is already in the user environment. Similarly, the intelligent purchasing agent accesses purchasing information from the order collection system. Thus, by assessing purchasing information accessed from the user environment, via the order collection system and the inventory collection system, the intelligent purchasing agent generates a consumer item order.

The trader unit receives each consumer item order from the intelligent purchasing agent. The trader unit includes a purchasing processor for selecting a communications network business to fulfill the consumer item order within the user parameters.

A computer code accompanies the purchasing system for buying consumer items from a communications network based on purchasing information. The computer code includes code for obtaining purchasing information from the user environment in accordance with parameters provided by a user. The computer code also includes code for generating a consumer item order by assessing the purchasing information.

In a further embodiment of the present invention, a method for buying consumer items from a communications network based on purchasing information gathered from a user environment, includes linking a monitoring unit with the user environment. Purchasing information is gathered from the user environment with the monitoring unit in accordance with parameters provided by the user. A purchasing unit is linked with the monitoring unit. A consumer item order is generated by means of the purchasing unit. The consumer item order is used to buy a consumer item from a communications network business via a trader unit.

### BRIEF DESCRIPTION OF THE DRAWINGS

Other objects, features, and advantages of the present invention will become more fully apparent from the following detailed description of the preferred embodiment, the appended claims and the accompanying drawings in which:

FIG. 1 is a schematic diagram illustrating a communications network based purchasing system according to the preferred embodiment of the present invention for obtaining purchasing information from a user environment and for buying goods and services based on the purchasing information obtained from the user environment;

FIG. 2 is a schematic diagram illustrating a purchasing system of FIG. 1 in greater detail;

FIG. 3 is a flow diagram illustrating a system configuration sequence executed by the purchasing system of FIG. 2 for gathering user parameters for use in obtaining purchasing information from the user environment;

FIG. 4 is a flow diagram illustrating an order collection sequence executed by an intelligent purchasing agent from the purchasing system of FIG. 2 for obtaining purchasing information from the user environment to generate a consumer item order;

FIG. 5 is a schematic diagram illustrating a trader unit from the purchasing system of FIG. 2; and

FIG. 6 is a flow diagram illustrating a purchasing sequence executed within a communications network by the trader unit of FIG. 5.

### DETAILED DESCRIPTION OF THE PREFERRED EMBODIMENT

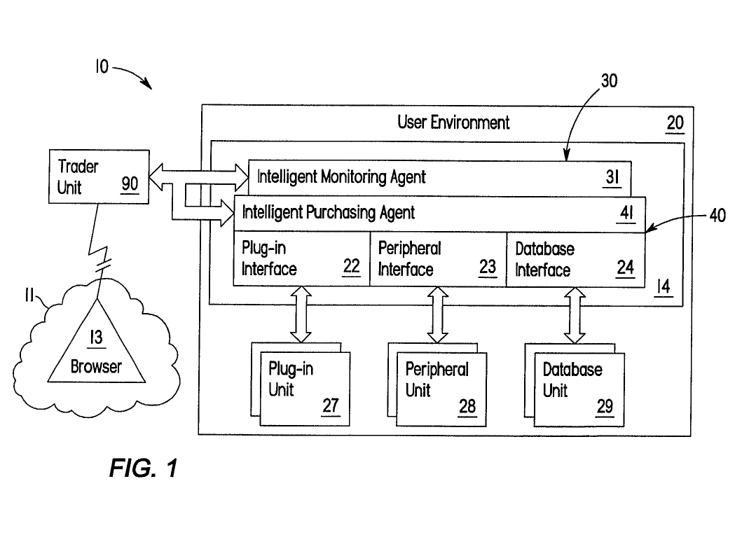

The preferred embodiment of the present invention is illustrated by way of example in FIGS. 1-6. With specific reference to FIG. 1, a purchasing system 10 includes a user environment 20. The purchasing system 10 is constructed of various software components for processes operating on a computer or a network of computers. In the preferred embodiment, the software components or processes composing the purchasing system 10 are configured for engagement with communication networks of a type well known in the industry, such as the Internet, for example. The user environment 20 is characterized as a user's surroundings for which the purchasing system 10 purchases consumer items. It should be added that the term “consumer item” refers to any good or service for consumption by the user environment 20.

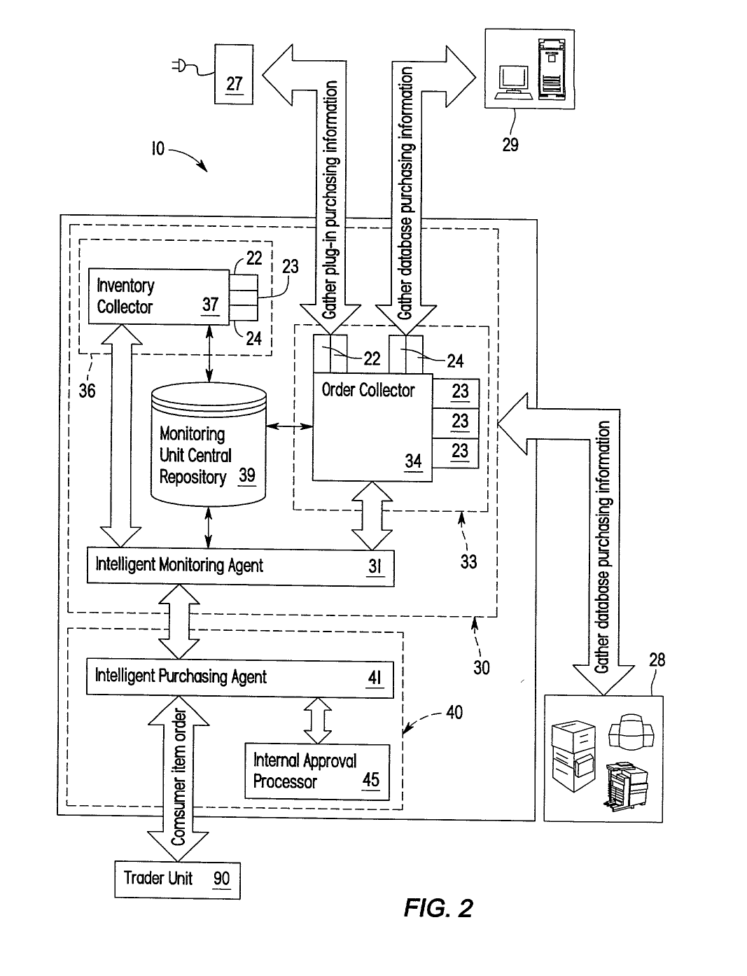

As illustrated in FIGS. 1 and 2, the user environment 20 includes at least one network plugin unit 27, at least one peripheral unit 28, and at least one database unit 29. The purchasing system 10 gathers purchasing information from the user environment 20 through the network plugin unit 27, the peripheral unit 28, and the database unit 29. In this disclosure and the appended claims the term “purchasing information” refers to any and all information associated with buying a consumer item for the user environment 20, such as quantity, size, price range, and delivery time, for example.

The network plugin unit 27, the peripheral unit 28, and the database unit 29 each preferably emit a consumer item demand signal providing purchasing information to the purchasing system 10. Referring to the user environment 20 shown in FIG. 1, the network plugin unit 27 is any electrical device, including electrical appliances, that is accessible to the purchasing system 10 via network protocols. Purchasing information from the network plugin unit 27 relates to consumer items associated with that network plugin unit 27, such as a need for more light fixtures, timers, dimmers, and maintenance services for a building's electrical lighting, for example. In this example, a governing circuit for the building's lighting is thus linked to the network plugin unit 27 via network protocols.

The peripheral unit 28 is an electrical device for providing a critical supporting function for the user, such as for example a printer, a copier, or a facsimile machine. Purchasing information from a peripheral unit 28 relates to consumer items associated with that peripheral unit 28, such as toner cartridges and copier repair needs, for example.

The database unit 29 is a device by which a user can directly provide purchasing information to the purchasing system 10, such as a computer, a wireless device such as a wireless telephone or wireless Internet link device, a touch-tone terminal, or a cable outlet terminal, for example. Purchasing information associated with a database unit 29 relates to the database unit 29 itself such as goods and repair services, for the database unit 29. However, purchasing information associated with a database unit 29 also reflects other miscellaneous consumer item needs by the user environment 20 that can only be submitted by a user through the database unit 29, such as a user's magazine subscriptions or medical prescription lists, concert tickets, catering services or travel agency bookings.

As shown in FIGS. 1 and 2, the purchasing system 10 includes a monitoring unit 30 linked with the user environment 20, a purchasing unit 40 linked with the monitoring unit 30, and a trader unit 90 linked with the purchasing unit 40. Generally, the monitoring unit 30 obtains purchasing information from the user environment 20. As discussed in detail below, purchasing information is obtained in accordance with parameters provided by a user. The purchasing unit 40 assesses the purchasing information obtained by the monitoring unit 30 and generates a consumer item order from this assessment. In general, the trader unit 90 is preferably a network addressable device such as an Internet address or Universal Resource Locator (URL) for example. The trader unit 90 is linked with a communications network 11, wherein the communications network 11 preferably comprises the Internet. In the operation of the purchasing system 10, the trader unit 90 buys a consumer item from the communications network 11 based on the consumer item order.

Prior to operation of the purchasing system 10, the trader unit 90 is initially accessed by a user through a browser 1 3, shown in FIG. 1, which facilitates user access through a graphical format. The browser 13 is of a type well known in the art, such as NETSCAPE NAVIGATOR or MICROSOFT EXPLORER for example. Other embodiments of the purchasing system 10, however, do not use a browser for access to the trader unit 90.

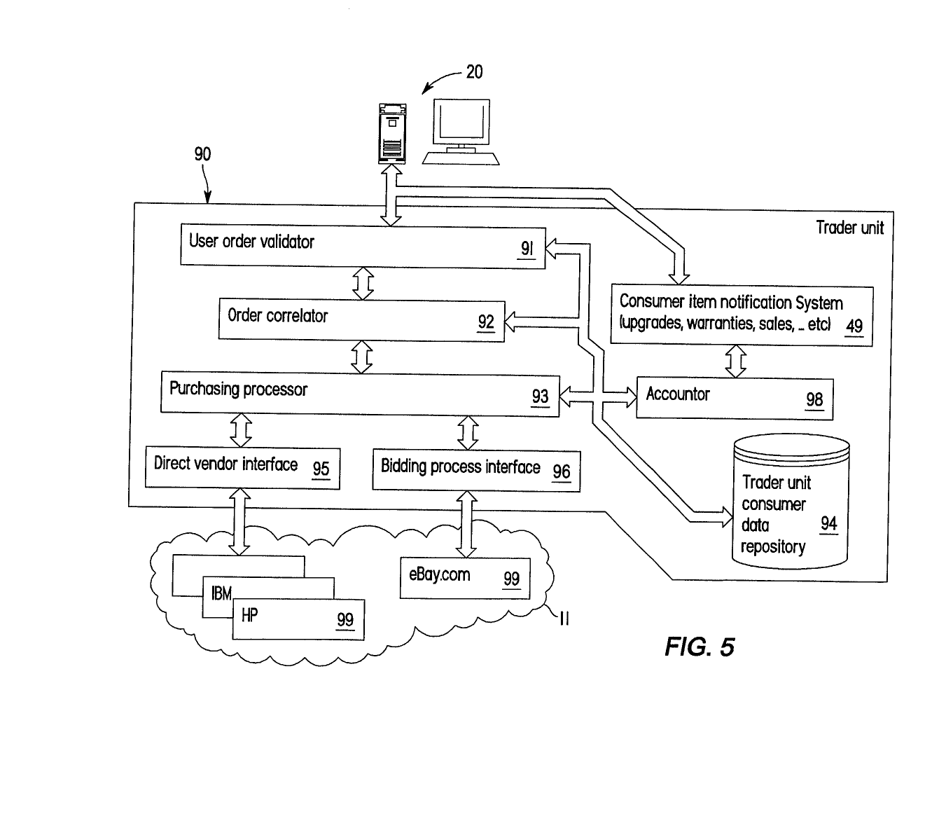

Generally, referring to FIGS. 1 and 5, the trader unit 90 includes an accountor 98. The accountor 98 initially operates to install onto a user's host database 14 applications software, including the monitoring unit 30 and the purchasing unit 40 for accessing a communications network business through the trader unit 90. Once installed, the accountor 98 interfaces with the downloaded application software, especially the purchasing unit 40, to facilitate each user's consumer needs. Post installation operation of the accountor 98 will be discussed further below.

Particularly, during initial installation, the accountor 98 contains a computer program sequence for installing the purchasing system 10 onto the user's host database 14 within the user environment 20. Illustratively, the user's host database 14 includes the memory of a personal computer or that of a wireless device, such as a telephone, such that the purchasing system 10 is accessed by a user as a desktop application, for example.

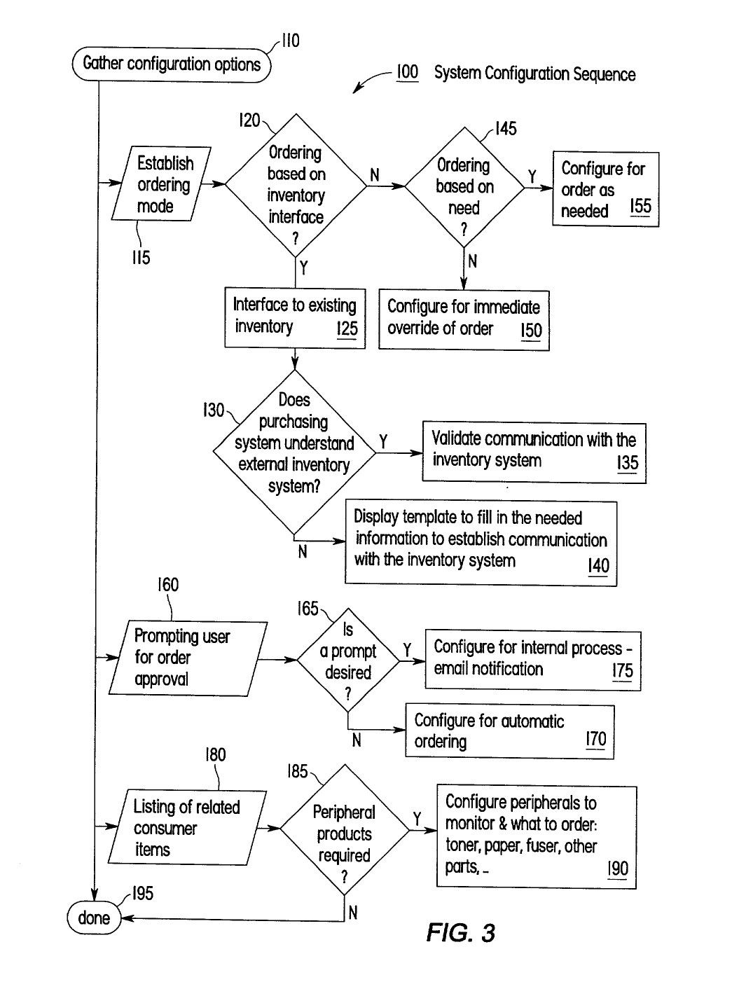

In a preferred embodiment, the monitoring unit 30 and the purchasing unit 40 are computer readable code on computer readable media. The monitoring unit 30 and the purchasing unit 40 are thus downloaded so that the trader unit 90 is linked with the user environment 20 through the monitoring unit 30 and the purchasing unit 40 within the user's host database 14. As discussed below, during installation of the purchasing system 10 onto the user's host database 14, the accountor 98 executes a system configuration sequence 100 (See FIG. 3) to obtain initial user parameters that are required for operating the purchasing system 10. Once installed, the purchasing system 10 is engaged for operation such that the monitoring unit 30 and purchasing unit 40 are activated on the user's host database 14.

With specific reference to FIG. 2, the monitoring unit 30 includes an order collection system 33 for sensing a consumer item demand signal from the user environment 20, preferably emitted from the network plugin unit 27, the database unit 29, and/or the peripheral unit 28. It should be said, however, that those of ordinary skill in the art will recognize devices within the user environment 20, other than the network plugin unit 27, the database unit 29, and/or the peripheral unit 28, for emitting a consumer item demand signal that indicates purchasing information relevant to the user environment 20.

Monitoring unit 30 includes an order collector 34 as well as at least one network plugin interface 22, peripheral interface 23, and database interface 24 each connected to the order collector 34. As shown in FIG. 1, the network plugin interface 22 is linked to the network plugin unit 27, the peripheral interface 23 is linked to the peripheral unit 28, and the database interface 24 is linked to the database unit 29 so that order collection system 33 receives purchasing information from the user environment 20. It should be added that the order collection system 33, as well as the entire purchasing system 10, preferably includes code in a metadata language, such as XML for example, to accommodate purchasing information from different sources, via SQL queries or email filters for example. As such, the order collector 34 senses for a consumer item demand signal from the user environment 20. Preferably, the order collector 34 senses the user environment 20 continuously.

With continuing reference to FIG. 2, the monitoring unit 30 includes an intelligent monitoring agent 31 and a monitoring unit central repository 39, each linked with the order collector 34. The intelligent monitoring agent 31 generates purchasing information from each consumer item demand signal received from the user environment 20. That is, the intelligent monitoring agent 31 filters each consumer item demand signal for purchasing information in accordance with parameters provided by the user. The user parameters, in turn, are obtained by the purchasing unit 40, as discussed in detail below, so that the entire purchasing system 10, including the intelligent monitoring agent 31, may access these parameters. The monitoring unit central repository 39 stores all information collected from the user environment 20. In particular, the monitoring unit central repository 39 stores purchasing information from the intelligent monitoring agent 31 as well as consumer item demand signals from the order collector 34. Illustratively, in operation, the monitoring unit central repository 39 stores information so that the intelligent monitoring agent 31 establishes purchasing trend(s) for consumer items in the user environment 20.

The monitoring unit 30 further includes an inventory collection system 36 linked with the monitoring unit central repository 39 and with the intelligent monitoring agent 31. The inventory collection system 36 includes an inventory collector 37 as well as at least one network plugin interface 22, peripheral interface 23, and database interface 24, each connected to the inventory collector 37. Whereas the order collector 34 determines whether there is a demand for a consumer item by the user environment 20, the inventory collector 37 determines whether the user environment 20 already has that consumer item in stock. Similar to the order collector 34, the inventory collector 37 senses for a consumer item stock signal from the user environment 20. Each consumer item stock signal is emitted from the user environment 20 by a network plugin unit, a database unit, and/or a peripheral unit (not shown). The consumer item stock signal preferably comprises simple network management protocols, SNMPs. In the preferred embodiment, the inventory collector 37 senses the user environment 20 continuously.

In the same manner as the order collector 34 and the intelligent monitoring agent 31, the monitoring unit central repository 39 stores consumer item stock signals and associated purchasing information from the inventory collector 37 and from the intelligent monitoring agent 31. Ultimately, the intelligent monitoring agent 31 accesses the monitoring unit central repository 39, the order collection system 33, and the inventory collection system 36, and provides purchasing information from each to the purchasing unit 40. Thus, from this purchasing information, the purchasing unit 40 assesses which consumer items need to be purchased and which consumer items are already in stock within the user environment 20.

Once again, the purchasing unit 40 includes an intelligent purchasing agent 41. The intelligent purchasing agent 41 is linked with the monitoring unit 30 through the intelligent monitoring agent 31. In effect, the intelligent purchasing agent 41 performs the central or “higher” logic functions for the purchasing system 10. That is, the intelligent purchasing agent 41 assesses purchasing information. Accordingly, by assessing purchasing information with respect to parameters provided by a user of the purchasing system 10, the intelligent purchasing agent 41 determines whether or not to purchase consumer items for the user environment 20. In addition, the intelligent purchasing agent 41 preferably facilitates gathering of parameters from the user. When it determines a need for buying a consumer item, the intelligent purchasing agent 41 also generates a consumer item order based on user parameters and purchasing information.

In a preferred embodiment, the intelligent purchasing agent 41 gathers user parameters via the system configuration sequence 100 shown in FIG. 3. For the purposes of the present invention, the term “user parameters” refers to purchasing guidelines for use by the purchasing system 10 and represents a specific type of purchasing information collected from the user environment 20. For example, user parameters may include a user's address, bank or smart payment card number, preferred methods for shipping, preferences for group purchasing discounts, and a user's price range for a desired consumer item, among others. User parameters are gathered for enhancing the accuracy of what consumer item is needed as well as for enhancing automation of the purchasing selection sequence executed by the purchasing system 10.

During operation, the purchasing system 10 preferably gathers user parameters either directly from a user via a database interface or through establishing purchasing trends for various consumer items. Purchasing trends are established by the intelligent purchasing agent 41 by assessing purchasing information stored within the monitoring unit central repository 39. For example, the purchasing system 10 installed in an accounting firm establishes a trend that shows that every April the firm orders a greater amount of printer toner due to excessive printing during the April 15^{th} U.S. federal income tax deadline.

Direct gathering of user parameters is accomplished in two instances. As discussed above, during installation of the purchasing system 10 on the user's host database 14, the trader unit 90 executes the system configuration sequence 100 to gather initial user parameters for operating the purchasing system 10. On the other hand, during operation of the purchasing system 10, the intelligent purchasing agent 41 updates old parameters as well as gathers new parameters via the system configuration sequence 100.

The intelligent purchasing agent 41 is prompted by a user, via a user directory, to execute the configuration sequence 100. In the preferred embodiment, the user directory is integrated with the user's database 14 operating software, preferably accessed through a toolbar. Thus, user parameters are entered through an electronic index card, such as cards in Microsoft Corporation's MS Exchange global address book or Apple Corporation's HyperCard.

Each card represents user parameters for a single consumer item. Therefore, a user may assign different parameters for different consumer items so that a series of cards is created. Ultimately, each card is included within the purchasing information associated with each consumer item order. Internal to the purchasing system 10, each card is assessed by the intelligent purchasing agent 41 and the purchasing processor 93 (See FIG. 5, for example) to accurately fulfill a consumer item order in accordance with user demand. Illustratively, for example, a user selects an appropriate card for a desired consumer item so that the associated user parameters are used during operation of the purchasing system 10 to obtain a selected consumer item.

The system configuration sequence 100 is executed by the intelligent purchasing agent 41 that gathers user parameters during operation of the purchasing system 10. Referring to FIG. 3, the system configuration sequence 100 initiates in step 110 program code for gathering user parameters or “configuration options”. In step 115, user input parameters are received to assist the intelligent purchasing agent 41 in generating a consumer item order. In particular, step 120 determines whether the user would like the intelligent purchasing agent 41 to interface with the inventory collection system 36 at step 125 prior to generating a consumer item order for buying a consumer item. If this inventory inquiry is desired by the user, intelligent purchasing agent 41, step 130 determines whether the software language of the purchasing system 10 is compatible with and, thus, understands the language of information collected from the user environment by the inventory collection system 36. Step 130 is especially helpful in occasions where the inventory collection system 36 is not fully automated or does not facilitate a common network protocol. If the purchasing system 10 understands the inventory collection system 36 language, the intelligent purchasing agent 41 establishes communication with the inventory collection system 36 before advancing to step 145. If the purchasing system 10 does not understand the language, a template is displayed in step 140 prompting the user to enter the requisite information for establishing communication with the inventory collection system 36 before advancing to step 145. As mentioned above, the inventory collection system 36 preferably includes at least one network plugin interface 22, peripheral interface 23, and at least one database interface 24 for obtaining purchasing information regarding user environment 20 inventory.

In step 145, the intelligent purchasing agent 41 establishes whether to catagorize a level of urgency for a consumer item order. If level categorization is required, the intelligent purchasing agent 41 determines if the urgency is preferably categorized as “group order withheld” or “as needed” before advancing to step 160. To achieve a large quantity or “bulk” discount purchase, a “group order withheld” categorization collects a predetermined amount of consumer item orders before the trader unit 90 makes a single group purchase. As discussed in detail below, the consumer item orders are collected and held by the trader unit 90. An “as needed” categorization enables the intelligent purchasing agent 41 to buy a consumer item as demand arises so that the item is never stored as inventory, for example buying printer toner only when the printer is out of toner. However, if level categorization is not required by the user, the intelligent purchasing agent 41 in step 150 thus recognizes every consumer item order as an immediate order before advancing to step 160. However, in step 155, the intelligent purchasing agent 41 recognizes order as an “as needed” consumer item order before advancing to step 160.

In step 160, user input is received as to whether an internal approval processor 45 of FIG. 2 should be activated. Step 165 determines whether the intelligent purchasing agent 41 is to activate the internal approval processor 45 during operation of the purchasing system 10 for every consumer item order. Therefore, when activated, the internal approval processor 45 prompts a user by giving notice that the purchasing system 10 is going to fill the consumer item order. If a prompt is desired for a consumer item only, then the internal approval processor 45 in step 175 notifies the user for permission as to whether the purchasing system 10 should proceed with buying that particular consumer item. Alternatively, if a prompt is not desired, the purchasing system 10 in step 170 buys a consumer item without notifying and awaiting final approval from the user. The system configuration sequence 100 in steps 170 and 175 then advances to step 180.

In step 180, user input parameters are received to assist the intelligent purchasing agent 41 in generating a consumer item order. Specifically, step 180 determines whether a user would like to consider purchasing other consumer items that are related to the consumer item for which an order is to be generated. If desired, the system configuration sequence 100 advances from step 180 to step 185, otherwise the sequence 100 advances from step 180 to step 195. In step 185, the intelligent purchasing agent 41 determines whether the desired consumer item requires additional orders for related peripheral products, for example determining whether a user environment requires a printer if a personal computer is purchased. If peripheral consumer items are needed, the purchasing agent in step 190 executes the system configuration sequence 100 for each required peripheral consumer item before advancing to step 195. Accordingly, step 195 completes the system configuration sequence 100.

In operation, the intelligent purchasing agent 41 initially receives purchasing information prompted by a consumer item demand signal from the user environment. In the preferred embodiment, the consumer item demand signal comprises simple network management protocols, SNMPs. The intelligent purchasing agent 41 accesses the inventory collection system 36 for purchasing information indicating whether a consumer item is already available in the user environment 20. If available, the intelligent purchasing agent 41 notifies the user and resumes monitoring for purchasing information prompted by another consumer item demand signal. If the consumer item is unavailable, the intelligent purchasing agent 41 assesses the purchasing information and user parameters to generate a consumer item order. The intelligent purchasing agent 41 then forwards the consumer item order to the trader unit 90. The trader unit 90, in turn, locates an appropriate seller within the communications network 11 and forwards the consumer item order for the desired consumer item for use by the user environment 20.

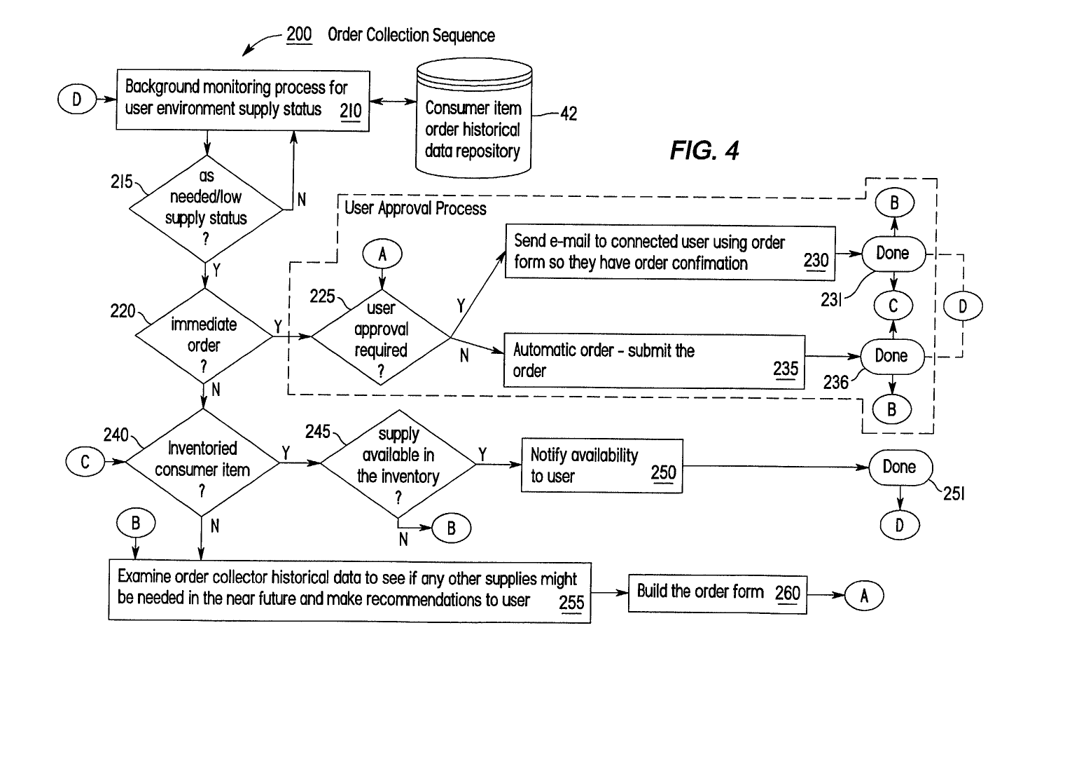

With specific reference to FIG. 4, the intelligent purchasing agent 41 executes an order collection sequence 200 for obtaining purchasing information from the user environment 20 to generate a consumer item order. Illustratively, the order collection sequence 200 is based on the user parameters established by the system configuration sequence 100 of FIG. 3. In particular, the order collection sequence 200 is based on the user parameters accounting for “as needed” or immediate purchasing as well as checking for identical consumer items in inventory. Therefore, it must be said that those of ordinary skill in the art will recognize other embodiments for the order collection sequence 200 to generate a consumer item order so long as the sequence 200 is based on a set of user parameters collected by the system configuration sequence 100.

According to the order collection sequence 200, the intelligent purchasing agent 41 in step 210 continuously monitors the user environment 20 via the monitoring unit 30 for purchasing information based on a consumer item demand signal. It should be added that the intelligent purchasing agent 41 includes consumer item order historical data repository 42. The consumer item order historical data repository 42 stores consumer item orders previously generated by the intelligent purchasing agent 41. In the preferred embodiment, the consumer item order historical data repository 42 stores a group of consumer item orders to facilitate group ordering for a discounted price. Therefore, in step 210, once it receives a consumer item demand signal, the intelligent purchasing agent 41 accesses associated purchasing information via the intelligent monitoring agent 31 before advancing to step 215. Additionally, the intelligent purchasing agent 41 accesses related consumer item orders within the consumer item order historical data repository 42.

In steps 215 and 220, the intelligent purchasing agent 41 determines the level of urgency for a resulting consumer item order with respect to the consumer demand signal. In particular, the intelligent purchasing agent 41 in step 215 determines whether the consumer item order is for immediate or “as needed” ordering. Accordingly, for “as need” ordering, the intelligent purchasing agent 41 in step 215 establishes a loop whereby the order collection sequence 200 will not advance to step 220 until the intelligent purchasing agent 41 determines that a consumer item within the user environment 20 is low in supply or is no longer available, i.e. if the consumer item is “as needed”. Upon advancing to step 220, an “as needed” consumer item order is executed in an identical manner as that of an immediate order described below.

Alternatively, if an immediate order is required, step 220 advances to step 225 otherwise step 220 will advance to step 240. Steps 225 through 236 refer to the user approval process executed by the internal approval processor 45.

For an immediate order, if user approval is required, step 225 advances to step 230 to notify the user and receive approval from the user for purchasing a consumer item. Preferably, notification and approval is conducted via Simple Mail Transfer Protocol. The intelligent purchasing agent 41 then advances from step 230 to step 231. Typically, for an immediate order, the order collection sequence 200 will advance from step 231 to step 240 for a consumer item availability verification from the inventory collection system 36, referenced in Figure for as the letter “C.” For an extremely urgent immediate order, the order collection sequence 200 advances from step 231 to step 255, referenced in FIG. 4 as the letter “B”, to generate a consumer item order for presentment to the trader unit 90.

On the other hand, if user approval is not required, step 225 advances to step 235 to begin generating a consumer item order for the immediate need. Therefore, if a consumer item availability verification from the inventory collection system 36 is indicated by the consumer demand signal, the order collection sequence 200 advances from step 235 through step 236 to step 240 for an immediate order as is preferred. This verification is referenced in FIG. 4 as the letter “C” in step 236. Optionally, if verification from the inventory collection system 36 is not desired, the order collection sequence 200 advances from step 235 through step 236 to step 255 to generate a consumer item order for presentment to the trader unit 90. This is referenced as the letter “B” in FIG. 4.

In steps 240 through 251, the intelligent purchasing agent 41 determines whether the desired consumer item is already available in the user environment 20. In step 240, the intelligent purchasing agent 41 determines whether the consumer item is used by the user environment 20. If never used before, the order collection sequence 200 advances from step 240 to step 255 to begin the process for generating the consumer item order. However, if used by the user environment 20, the intelligent purchasing agent 41 accesses the inventory collection system 36 in step 245 to determine whether the desired consumer item is already available in the user environment 20.

If used by the user environment 20 but not currently available in inventory, the order collection sequence 200 advances from step 245 to step 255 to begin generating a consumer item order. However, if available in inventory, the intelligent purchasing agent 41 in step 250 engages the internal approval processor 45 so that the user is notified of availability in lieu of generating a consumer item order. If an inventory item is available, the order collection sequence 200 for that particular consumer item is completed and thus the sequence loops back to step 210 to monitor the user environment 20 as referenced in FIG. 4 as the letter “D”.

In step 255, the purchasing agent 41 accesses the order collection system 33, the inventory collection system 36 as well as the consumer item order historical data repository 42. The intelligent purchasing agent 41 thus assesses relevant purchasing information from these sources to determine whether other related consumer items are needed. Accordingly, the intelligent purchasing agent 41 in step 255 recommends the optimal money and time saving manner by which to obtain consumer items for the user environment 20 before advancing to step 260. In step 260, the intelligent purchasing agent 41 generates a consumer item order for transmittal to the trader unit 90.

After step 260, the order collection sequence 200 advances to the user approval process of steps 225 through 236 as discussed above for immediate ordering. However, in contrast to the immediate ordering request, steps 231 and 236 require different procedures once a consumer item order is generated in step 260. This different procedure is indicated in dashed lines in FIG. 4. Thus, after determining whether user approval is required in steps 225 as well as 230 or 235, the intelligent purchasing agent 41 in either step 231 or 236 forwards the consumer item order to the trader unit 90 as well as loops back to step 210 to begin monitoring for another consumer item demand signal from the user environment 20. This different procedure is referenced in FIG. 4 as the letter “D” with dashed lines.

Accordingly, the trader unit 90 receives each consumer item order from the user environment 20 via the intelligent purchasing agent 41. Referring to FIG. 5, the trader unit 90 includes a user order validator 91 linked with the intelligent purchasing agent 41 and with the accountor 98. By accessing information provided by the accountor 98, the user order validator 91 verifies whether the user may legitimately access the trader unit 90 to fulfill the consumer item order.

Optionally, the user order validator 91 collects revenue. Therefore, without providing sufficient funds to the user order validator 91, a user may not legitimately access the trader unit 90.

The trader unit 90 includes an order correlator 92 linked with the user order validator 91 and the accountor 98. The order correlator 92 receives purchasing information from the accountor 98 as well as relevant consumer item orders associated with every user. The accountor 98, in turn, retrieves this customer specific purchasing information and previously fulfilled consumer item orders from a trader unit customer data repository 94 that is provided by the trader unit 90. Contrastingly, where the trader unit consumer data repository 94 stores previously fulfilled consumer item orders for tracking purposes, the consumer item order historical data repository 42, discussed above, stores unfulfilled consumer item orders to facilitate group ordering.

The order correlator 92 thus submits the consumer item order from the purchasing unit 40, as well as purchasing information and previously fulfilled consumer item orders from the accountor 98, to a purchasing processor 93. The purchasing processor 93 is linked with the order correlator 92, the accountor 98, and the trader unit customer data repository 94. Ultimately, the trader unit 90 provides the purchasing processor 93 the information necessary for selecting a communications network business to fill each consumer item order sent by the intelligent purchasing agent 41.

The purchasing processor 93 includes a direct vendor interface 95 and a bidding process interface 96. The direct vendor interface 95 and the bidding process interface 96 are each connected to the communications network 11 to enable the purchasing processor 93 to buy a consumer item from the communications network 11 based on the consumer item order. The purchasing processor 93 fulfills the consumer item order by selecting a communications network business 99 from a group of communication network businesses. A communications network business refers to any business that conducts business transactions through a communications network 11, such as “www.shopping.HP.com” or “www.eBay.com”, for example. Selection is based on all information related to the consumer item order. Specifically, the consumer item order and user parameters from the purchasing unit 40 as well as customer specific purchasing information and previously fulfilled consumer item orders from the accountor 98. The purchasing processor 93 coordinates with businesses on the communications network 11 via manual processes or with business-to-business protocols, such as Microsoft Corporation's BizTalk for example.

In particular, the direct vendor interface 95 and the bidding process interface 96 are each linked with at least one communications network business 99. The direct vendor interface 95 is preferably linked with a communications network business 99 that directly sells the requisite consumer item. For example, if the user environment 20 requires replacement batteries for a current model scientific calculator, the direct vendor interface 95 accesses a communications network business 99 that sells replacement batteries, such as a Hewlett Packard Product Internet Website for example. Similarly, on the other hand, the bidding process interface 96 is preferably linked with a communication network business 99 that provides the requisite consumer item in an auction-style purchasing format. For example, if the user environment 20 requires difficult-to-find replacement batteries for an antique 1970s scientific calculator, the bidding process interface 96 accesses a communications network business 99 that, like an auctioneer, accepts bids for antique replacement batteries, such as “www.eBay.com” Internet website for example.

In addition, the accountor 98 tracks each consumer item order executed by the purchasing processor 93. The accountor 98 stores information relating to each consumer item order in the trader unit consumer data repository 94. The accountor 98 provides executed consumer item orders from the trader unit user data repository 94 to the purchasing processor 93 to facilitate selection of a communications network business. From the executed consumer item orders, the accountor 98 may establish a financial trend. Thus, the accountor 98 may provide financial information reporting to the purchasing processor 93 and directly to the user environment 20 via the intelligent purchasing agent 41. Ultimately, by interfacing with the accountor 98 as well as with the communications network businesses 99, the purchasing processor 93 can easily access purchasing information so that the user may comparison shop.

The trader unit 90 may include a consumer item notification system 49 linked with the accountor 98 and the intelligent purchasing agent 41. Through the accountor 98, the consumer item notification system 49 tracks executed consumer item orders. Accordingly, the consumer item notification system 49 provides related consumer item information to the user environment 20, such as other consumer items of interest, relevant discount sales information, product end-of-life warnings, and possible consumer item upgrades. In the preferred embodiment, the intelligent purchasing agent 41 provides this information from the consumer item notification system 49 to the user environment 20 during the order collection sequence 200.

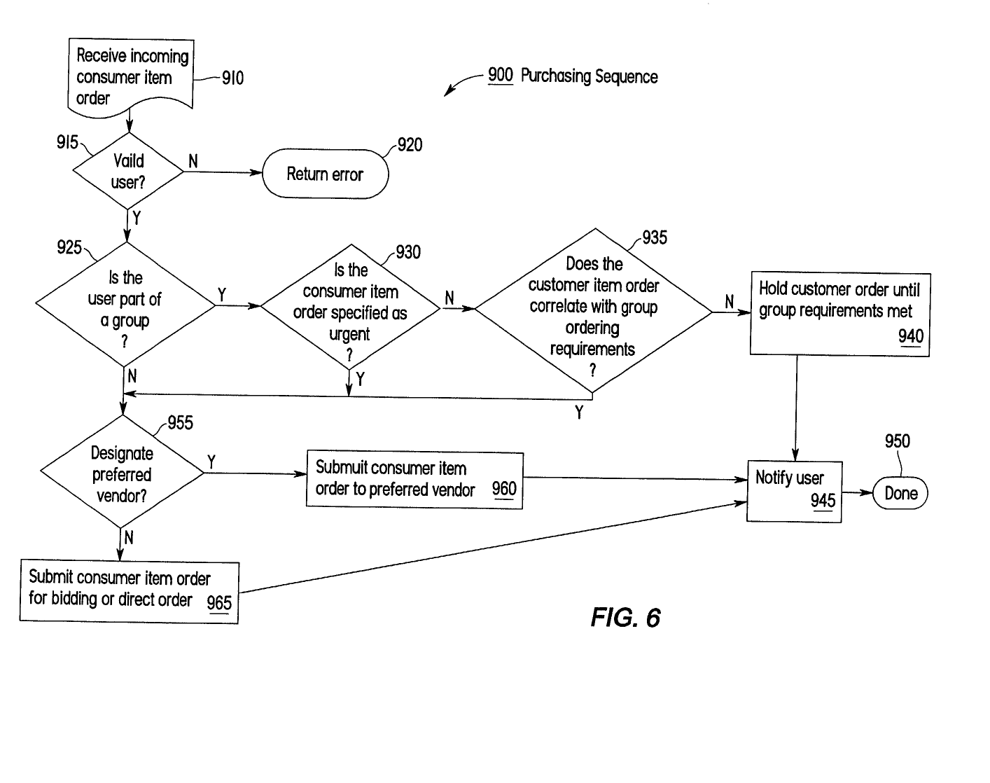

In the preferred embodiment, the trader unit 90 implements a purchasing sequence 900 with each consumer item order. Through the purchasing sequence 900, as shown in FIG. 6, the trader unit 90 receives a consumer item order from the intelligent purchasing agent 41 and selects a communications network business 99 that optimally fulfills the consumer item order.

Initially, in step 910, the user order validator 91 receives the incoming consumer item order. In step 915, the user order validator 91 determines whether a user may legitimately access the trader unit 90. If an invalid user attempts to access the trader unit 90, the purchasing sequence 900 advances from step 915 to step 920 to execute an error message denying further access to the trader unit 90. For a valid user, the purchasing sequence 900 advances from step 915 to step 925 such that the consumer item order advances from the user order validator 91 through the order correlator 92.

By accessing the accountor 98, the order correlator 92 in step 925 determines whether the user is part of a group or an individual, such as, for example, whether a user is accessing the trader unit 90 on behalf of a corporate account or for personal interests. If the user is part of a group, the purchasing sequence 900 advances from step 925 to step 930. The purchasing processor 93 in step 930 assesses the level of urgency of the consumer item order as determined by the intelligent purchasing agent 41. If the consumer item order is urgent, the purchasing sequence 900 advances from step 930 to step 955. However, if the consumer item order is not urgent, the purchasing sequence advances from step 930 to step 935.

In step 935, the purchasing processor 93 determines whether the consumer item order fulfills user parameters established by the group, such as whether the relevant consumer item is within a price range established by the group. If the user parameters are fulfilled, the purchasing sequence 900 advances from step 935 to step 955.

If the user parameters are not fulfilled, the consumer item order in step 940 is forwarded, without execution, to the consumer item order historical data repository 42 within the purchasing unit 40 until group requirements are made. Accordingly, the purchasing processor 93 in step 945 notifies the user of the withholding of the consumer item order before advancing to step 950 to complete the purchasing sequence 900.

In step 955, the purchasing processor 93 determines whether the consumer item order specifies a particular communications network business 99, such as specifying Hewlett Packard as the vendor for selling all replacement toner cartridges for a printer. If desired, the consumer item order is submitted to the particular communications network business 99 in step 960. The purchasing processor 93 notifies the user in step 945 that the consumer item order is submitted to the specific communications network business 99 before advancing to 950 to complete the purchasing sequence 900.

If there is no communications network business 99 preference, the purchasing system 900 advances from step 955 to step 965. In step 965, the consumer item order is submitted to a communications network businesses 99 that offers either direct sales or an invitation for bidding of the consumer item. In the preferred embodiment, the purchasing processor 93 accesses the consumer item order, purchasing information as well as user parameters to determine whether the consumer item order is best suited by either a direct purchase or an auction-type purchasing format communications network business 99. However, rather than the purchasing processor 93, other embodiments contemplate the user selecting between a direct purchase or an auction-type purchasing format.

The consumer item order is thus submitted to the communications network business 99 in step 960. The purchasing processor 93 notifies the user in step 945 that the consumer item order is submitted to the best suited communications network business 99 before advancing to step 950 to complete the purchasing sequence 900.

While the present invention has been disclosed in connection with the preferred embodiment thereof, it should be understood that there may be other embodiments which fall within the spirit and scope of the invention as defined by the following claims.

What is claimed is:

1. A purchasing system, the purchasing system buying consumer items from a communications network business through a communications network based on purchasing information gathered from a user environment in accordance with parameters provided by a user, comprising:
(a) a monitoring unit linked with the user environment, the monitoring unit obtaining purchasing information from the user environment in accordance with parameters provided by a user; and
(b) a purchasing unit linked with the monitoring unit, the purchasing unit generating a consumer item order by assessing the purchasing information.

2. The purchasing system according to claim 1 wherein the user environment includes:
(a) a network plugin device;
(b) a peripheral device; and
(c) a database device.

3. The purchasing system according to claim 1 further comprising a trader unit linked with the purchasing unit and with the communications network, the trader unit for selecting a communications network business for the consumer item order.

4. The purchasing system according to claim 2 wherein the monitoring unit includes:
(a) an order collection system for sensing a consumer item demand signal from the user environment; and
(b) an intelligent monitoring agent linked with the order collection system and with the purchasing unit for generating purchasing information from the consumer item demand signal.

5. The purchasing system according to claim 4 wherein the monitoring unit further includes an inventory collection system linked with the intelligent monitoring agent for sensing a consumer item stock signal from the user environment.

6. The purchasing system according to claim 5 wherein the purchasing unit includes an intelligent purchasing agent linked with the intelligent monitoring agent and with the trader unit for assessing the purchasing information.

7. The purchasing system according to claim 6 wherein the intelligent purchasing agent accesses purchasing information from the inventory collection system to determine whether a consumer item is in the user environment.

8. The purchasing system according to claim 6 wherein the intelligent purchasing agent accesses purchasing information from the order collection system.

9. The purchasing system according to claim 6 wherein the intelligent purchasing agent generates a consumer item order.

10. The purchasing system according to claim 9 wherein the trader unit receives the consumer item order from the purchasing unit.

11. The purchasing system according to claim 10 wherein the trader unit includes a purchasing processor for selecting a communications network business to fulfill the consumer item order.

12. The purchasing system according to claim 11 wherein the trader unit includes an accountor linked with the purchasing processor for tracking each consumer item order executed by the purchasing processor.

13. The purchasing system according to claim 1 wherein the communications network comprises the Internet.

14. In a computer system, computer code product on computer readable media for buying consumer items from a communications network business through a communications network based on purchasing information gathered from a user environment in accordance with parameters provided by a user, the computer code product comprising:
(a) a first computer code product for obtaining purchasing information from the user environment in accordance with parameters provided by a user; and
(b) a second computer code product for generating a consumer item order by assessing the purchasing information.

15. The computer code product according to claim 14 wherein the first computer code product includes:
(a) computer code product for sensing a consumer item demand signal from the user environment; and
(b) computer code product for generating purchasing information provided by the consumer item demand signal.

16. The computer code product according to claim 15 wherein the second computer code product includes computer code product for assessing the purchasing information from the first computer code product and for generating a consumer item order.

17. The computer code product according to claim 16 further comprising:
a third computer code product for buying a consumer item from the communications network based on the consumer item order.

18. The computer code product according to claim 16 wherein the third computer code product includes computer code product for selecting a communications network business in accordance with the consumer item order.

19. In an communications network environment, a method for buying consumer items from a communications network business through a communications network based on purchasing information gathered from a user environment in accordance with parameters provided by a user, comprising the steps of:
(a) linking a monitoring unit with the user environment;
(b) gathering purchasing information from the user environment with the monitoring unit in accordance with parameters provided by the user;
(c) linking a purchasing unit with a monitoring unit;
(d) assessing the purchasing information with the purchasing unit; and
(e) generating a consumer item order with the purchasing unit.

20. The method according to claim 19 further comprising the steps of:
(a) linking a trader unit with the purchasing unit and with the communications network; and
(b) buying a consumer item from the communications network with the trader unit based on the consumer item order.
